(19) United States
(12) Patent Application Publication
(10) Pub. No.: US 2026/0219908 A1
(43) Pub. Date: Jul. 30, 2026

(54) PROCESSING AN INPUT COMMAND USING CONDITIONAL DISTRIBUTED EXECUTION

(71) Applicant: International Business Machines Corporation, Armonk, NY (US)

(72) Inventors: Tareq Al-Maamari, Böblingen (DE); Simon Daniel Moser, Gärtringen (DE); Enrico Regge, Stuttgart (DE); Michael Behrendt, Sindelfingen-Maichingen (DE); Luca Stangohr, Karlsruhe (DE); Michael Beck, Bad Teinach-Zavelstein (DE); Sugandha Agrawal, Holzgerlingen (DE); Tobias Huschle, Gaertringen (DE)

(21) Appl. No.: 19/078,761

(22) Filed: Mar. 13, 2025

(30) Foreign Application Priority Data
Jan. 30, 2025 (GB) 2501326.9

(51) Int. Cl. G06F 9/455; G06F 9/38

(52) U.S. Cl. CPC G06F 9/45533; G06F 9/3824

(57) ABSTRACT

The invention relates to a method of processing an input command using a computing device configured for exchanging information with a computer network, the method comprising, by the computing device: in response to receiving a trigger signal configured to cause the computing device to process the input command, performing a processing routine comprising: in response to determining that the input command shall be processed using distributed execution: instantiating a first virtual processing entity within the computer network; triggering an execution of the input command using the first virtual processing entity, the execution resulting in a resulting output; receiving the resulting output from the computer network; providing the resulting output.

### BACKGROUND

The present invention relates to execution of a command on one or more computing devices within a computer network.

Executing a command by a single computing device such as a local computer workstation may exhibit a limited scaling behaviour in processing and memory capacities if the command requires processing large amounts of data. An additional limitation may arise from network capacity if data involved in the execution is exchanged between the local workstation and a computer network. A distributed execution of the command may avoid such limitations-

Distributed computing may typically require a dedicated setup such as a client-server architecture or a cluster having an orchestrator node. Spontaneous invocations of distributed computing may require a sophisticated manual setup and possibly also code reprogramming to enable distributed execution in the particular case. Some distributed processing setups may have no or only limited support for sequential processing jobs such as pipeline commands.

### SUMMARY

In one aspect, the invention relates to a method of processing an input command using a computing device configured for exchanging information with a computer network, the method comprising, by the computing device: in response to receiving a trigger signal configured to cause the computing device to process the input command, performing a processing routine comprising: in response to determining that the input command shall be processed using distributed execution: instantiating a first virtual processing entity within the computer network; triggering an execution of the input command using the first virtual processing entity, the execution resulting in a resulting output; receiving the resulting output from the computer network; providing the resulting output.

In another aspect, the invention relates to a computing device comprising a processor and a memory and being configured for exchanging information with a computer network, the memory storing program instructions which, when executed by the processor, cause the computing device to perform a method of processing an input command, the method comprising:
in response to receiving a trigger signal configured to cause the computing device to process the input command, performing a processing routine comprising: in response to determining that the input command shall be processed using distributed execution: instantiating a first virtual processing entity within the computer network; triggering an execution of the input command using the first virtual processing entity, the execution resulting in a resulting output; receiving the resulting output from the computer network; providing the resulting output.

In a further aspect, the invention relates to a computer program product comprising a computer readable storage medium having program instructions embodied therewith, the program instructions being executable by a processor of a computing device configured for exchanging information with a computer network, wherein execution of the program instructions by the processor causes the computing device to perform a method of processing an input command, the method comprising: in response to receiving a trigger signal configured to cause the computing device to process the input command, performing a processing routine comprising: in response to determining that the input command shall be processed using distributed execution: instantiating a first virtual processing entity within the computer network; triggering an execution of the input command using the first virtual processing entity, the execution resulting in a resulting output; receiving the resulting output from the computer network; providing the resulting output.

Examples described herein can be freely combined with each other if they are not mutually exclusive.

### BRIEF DESCRIPTION OF THE DRAWINGS

In the following, examples are explained in greater detail, by way of example only, making reference to the drawings in which:

FIG. 1 schematically depicts components of a computing device within a computing environment, according to various embodiments of the present disclosure.

FIG. 2 is a block diagram showing entities of a computer network involved in a processing of an input command using distributed execution, according to various embodiments of the present disclosure.

FIG. 3 is a block diagram showing entities of a computer network involved in a processing of a pipeline input command using distributed execution, according to various embodiments of the present disclosure.

FIG. 4A is one of a sequence of drawings 4A to 4C showing steps of a workflow effecting processing of a pipeline input command using distributed sequential and parallel execution at two different levels of detail, according to various embodiments of the present disclosure.

FIG. 4B is one of a sequence of drawings 4A to 4C showing steps of a workflow effecting processing of a pipeline input command using distributed sequential and parallel execution at two different levels of detail, according to various embodiments of the present disclosure.

FIG. 4C is one of a sequence of drawings 4A to 4C showing steps of a workflow effecting processing of a pipeline input command using distributed sequential and parallel execution at two different levels of detail, according to various embodiments of the present disclosure.

FIG. 5 is a flow diagram depicting possible steps of a method of processing an input command using conditional distributed execution, according to various embodiments of the present disclosure.

### DETAILED DESCRIPTION

While a local execution of a command may have a low administrative barrier, distributed command execution may have a versatile scaling behaviour. It therefore appears promising to combine both approaches to command execution.

The method outlined herein and defined by the claims is also referred to herein as “processing (of) an input command using conditional distributed execution” because the execution of the input command using the first virtual processing entity is subject to fulfilment of the condition that the input command shall be processed using distributed execution. The term “virtual processing entity” may be also referred to as “processing entity” and may be abbreviated as “PE”. Ordinal numberings of “(virtual) processing entity” may be abbreviated by numerals appended to the abbreviation “PE”, such as “first, second, . . . last virtual processing entity” by “PE1, PE2, . . . , PEn” with “n” denoting a total number of PEs and the sequential number of the last PE. The term “virtual storage entity” may be also referred to as “storage entity” and may be abbreviated as “SE”. The term “computing device” may be also referred to as “local workstation” and may be abbreviated as “LW”.

The method discussed herein is dedicated to processing or execution of an input command. The input command may comprise a single portion or element to be executed or may comprise multiple portions, elements, or subcommands to be executed. Each portion, element, or subcommand of the input command may comprise a reference to some form of executable logic to be executed, and optionally also arguments modifying the executable logic and/or specifying data to be processed by the executable logic and/or an address or other reference for handling data processed by the executable logic.

An execution of multiple subcommands may comprise a second subcommand that depends on the execution of a first subcommand, such that the first and second subcommands may be processed sequentially. An execution of multiple subcommands may comprise subcommands that do not depend on each other and may therefore be processed in parallel. In a sequence of subcommands, there may be one or more subcommands that is/are not followed by any further subcommand and may therefore be referred to as “last subcommand(s)”. In the case that the input command comprises one single subcommand, the first subcommand is equal to the last subcommand. Similarly, a PE generating output that is not used as input by any other PE may be referred to as a “last virtual processing entity/last PE”.

As described herein, a single subcommand may be processed by one or more PEs, and a single PE may process one or more subcommands of the input command. In this sense, a single subcommand does not necessarily have to be processed by a single PE, although a processing of each subcommand by a single PE may be a preferred case. In the case that the input command comprises one single subcommand, the first PE processing it may be or may be not identical to the last PE processing it. The input command may be given in a human-readable form such as a string entered on a command-line interface (CLI) of the computing device (LW), but may likewise be given in any other form of computer-executable code such as an object code or a binary code.

The LW may receive the input command and receives a trigger signal that is configured to cause the LW to execute the input signal. For instance, the trigger signal may be generated by a user of the LW operating an input device of the LW, such as pressing an “Enter” or “Return” key or pressing a mouse button; but may likewise be any other control signal configured for triggering execution of the input command by the LW, such as a corresponding signal issued by a process or thread started by a program, script, other process running on the LW or on a computing entity within the computer network. The trigger signal may generally be received via any external or internal interface of the LW.

The method comprises determining whether the input command shall be processed using distributed execution. Various kinds of criteria may be implemented to determine that the input command shall be processed using distributed execution, including, but not limited to determining: that the input command specifies input data that must be retrieved from the computing network; that a portion of input data to be retrieved via the computer network exceeds a predefined limit; that the input command comprises a (sub)command that is listed to be executed using distributed execution by default; that a resource onboard the LW is too limited to execute the input command locally; that a (sub)command of the input command is known to have a high ratio of output-to-input data volumes; that the input command comprises that hints to a possible occurrence of a high data volume (e.g., exceeding a predefined boundary) during the execution; etc. The computing device may maintain a (default and/or user-defined) policy specifying such criteria.

A policy may specify additional kinds of information related to the conditional distributed execution, which may include a specification of a resource on the computer network (e.g., a web or cloud service) that can be used for instantiating a virtual processing entity (PE), and optionally, a specification of a resource on the computer network that can be used for instantiating a storage entity (SE) as explained further below. Is shall be noted that an instantiation of a virtual entity is understood herein as a generation, creation, or start of a new instance of such entity that was not running before the processing routine reaches the point of said instantiation. The process of ending, removing, or destroying a running instance is referred to as a termination of that instance.

If the LW determines that the input command shall be processed using distributed execution, it instantiates a first virtual processing entity (PE1) within the computer network, using, for instance, cloud service information (descriptive of, e.g., a shared network computing resource, user account information, or the like) provided by the policy. The instantiation of a new PE may comprise making available to the PE at least any input data to be processed by the input command or its respective portion to be processed by the PE. The instantiation may further include making available to the PE any code (e.g., binary/object/script) to be executed by the PE; as well as applying further configuration as described herein.

The policy mentioned above may also be used to define parameters of execution for the (sub)commands on the LM side. Various approaches appear principally possible: For instance, the policy may specify a generic configuration that defines the default configuration applied for all (sub)commands executed by each wrapper; and/or a command specific override that defines which configuration values shall be applied for a specific command; and/or an operation-step specific override that defines which configuration values shall be applied for one or more of the operations defined in the input command. Policy configurations may be applied using environment variable(s), for example. The policy may also specify parameters of newly instantiated PEs, such as specifiers relating to a machine type, CPU architecture, OS, filesystem, permissions, etc.

Like any other virtual processing entity described herein, the first virtual processing entity may be equipped with a quota of computing resources such as processor capacity, allocated memory, network bandwidth, etc. A processing entity may furthermore be configured to match all requirements of the portion of code to be respectively executed by the PE, including, without limitation, requirements regarding hardware architecture, operating system (OS), pre-installed software including runtime libraries, etc. A processing entity may be a virtual server instance (VSI), a virtual machine, a container, or the like. Preferably, a PE is configured as lightweight as possible to ensure a maximum responsiveness and configurability.

It shall be noted that any function or feature described herein as a function or feature of the first PE may be an equally valid function or feature of any further PE participating in the execution of the input command using the first virtual processing entity. In particular, this may include, without limitation: processing a portion of the input command, including executing a job process incorporating a portion of the execution of the input command; exchanging information with another processing entity or a storage entity; and assuming a configuration required by the computing device.

The LM continues by triggering an execution of the input command using the first virtual processing entity. This includes causing the first virtual processing entity to perform at least one portion of the input command, while one or more further portions of the input command may be executed by one or more further (virtual or non-virtual) processing entities, which may include the computing device itself. In an example, the input command is completely processed by resources of the computer network, meaning that the computing device does not process any portion of the input command. In another example, a portion of the input command is processed by resources of the computing network, and another portion of the input command is processed by the computing device.

After completion of the execution of the input command, the LM receives the resulting output from the computer network, e.g., from one or more processing entities having executed a portion of the input command, and/or from a storage entity within the computer network where one or more of the executing entities have stored the output resulting from their respective portion of the execution. Without limitation, the receipt of the resulting output may include a push mechanism where the respective PE spontaneously transmits its respective portion of the resulting output to the LM without prior notice; and/or a pull mechanism where the LM fetches (in response to or without availability notice) the resulting output from the respective PE and/or an SE where portions of the resulting output have been written to.

The LM then continues by providing the resulting output, processing it in an identical manner as if the input command had been executed solely by the LM itself. Non-limiting examples thereof may include: passing the resulting output to an output data stream—in particular, but without limitation, a standard stream such as the standard output (stdout)—or equivalently, to a handle configured for handling output data; directing the resulting output to an output device/internal and/or external interface of the computing device; storing the resulting output in volatile and/or non-volatile memory of the computing device; etc.

More specifically, a PE may send to the LW a notification message indicating completion of the portion of the input command respectively executed by the PE, and/or may send to the LW the respective portion of (respective intermediate or resulting) output generated by the execution of said respective portion. In either case, the message sent may contain one or more specifiers indicating the output data stream, handler, channel, bus, address, port, or other identifier of any data handling structure(s) at which the respective portion of the resulting output was received at the respective PE. This may enable the computing system to hand each respective portion of the intermediate or resulting output over to a data handling structure onboard the computing device that is equal or equivalent to the data handling structure respectively specified in the return message or signal. In an example, a portion of code that is processed on a Unix PE results in a portion of the resulting output that is given to the standard output (stdout). The PE may then inform the LM that the output is received at stdout, such that the LM may then provide said portion of the resulting output to its own standard output data stream or handle, depending on its OS.

Information exchange between the LW and the instantiated processing entities may be enabled using various known approaches available on the market. However, it may be possible to achieve this with out-of-the-box means provided by the respective OSs of the LM and the PEs that may be available without any further setup or configuration, thus probably keeping the effort of processing entity instantiation and the PEs'resource footprints at a minimum. Examples herein refer to socat, which may be available on many Unix-based systems to provide enhanced network connectivity on data stream level, and many similar software tools may be available on other OS types. The computer network may be considered as the internet, a cloud network, an intranet, or any other network-based platform capable of performing distributed execution using virtual processing entities.

Throughout the performance of the method, the computing device may stay in control of all instantiations, execution triggers, configurations, output receipts, and other parts of the execution of the input command performed by entities in the computer network. The method may be implemented as local software provisioned or running on the computing device, including, but not limited to, a runtime library, and/or a running executable process, in particular a background process such as a service or daemon, together with a set of configurational data, files, environment variables, etc. incorporating a policy as described herein.

The method described herein may have the advantage that an input command fulfilling a condition for distributed execution may be executed in a distributed manner, but without the need for a user to set up a dedicated architecture for distributed execution beforehand. The method may minimize a user's requirement for adapting code associated with the input command for achieving an adaptation to a particular system supporting distributed execution, and may even enable issuing the input command without any code adaptations if the method is made transparent as described herein. This may reduce the user's administrative and educational burden for enabling spontaneous distributed execution of commands, which may be especially useful if the user is a software developer, administrator, or other user type regularly requesting command execution via a command-line interface (CLI).

Moreover, the conditional distributed execution provided by the method may significantly reduce the resource consumption of the LW for processing large amounts of data, leaving the resource consumption associated with the execution largely to the scalable resources of the computer network. In an example, the input command requires processing of data included in the Common Crawl archive, which is an example of a huge data set (Petabyte-scale in total as of 2024), of which excerpts are often used in the course of development tasks such as training artificial intelligence (AI) models. Local execution of such input command may require the computing device to load gigabytes of data via its network interface, process the data using its limited local processing resources, and optionally, write gigabytes of output data back to an online repository for future reference. Scenarios such as this may be easily avoided using the approach of conditional distributed execution described herein.

A further advantage of the method may include the possibility of remotely executing commands with a remote depth greater than 1. As the LW may stay in control of the distributed processing, it may set and scale the number of virtual processing entities according to real-time requirements of the execution, and configure the virtual processing entities to account for dependencies in the flow of execution. Examples of this increased flexibility are given in the course of the following description.

Advantages of the method may be made possible by a difference in the architecture underlying the method in comparison to many known orchestrator-cluster or client-server setups. According to the present method, the computing device may be configured to use resources of the computer network as a service provider for performing command executions using virtual processing entities that may be instantiated on demand. The present architecture may thus be described more precisely as a cloud-client architecture. In particular, but not necessarily, the computing device may be a local workstation (LW), such as a laptop, with limited scaling capabilities. Apart from a one-time configuration of the software layer effecting the conditional distributed execution to set up online resources for instantiating PEs, setting general, user and/or case specific policy rules, etc., the LW may decide automatically whether a specific input command should be executed locally or in a distributed manner. Preferably, the processing routine is transparent to the user, in a sense that the user may be unable to tell if the input command is executed locally or not unless the user actively monitors parameters of the execution.

An example relates to the case that the input command comprises: a first subcommand, wherein execution of the first subcommand results in a first intermediate output; a second subcommand, wherein execution of the second subcommand results in a second intermediate output; and a pipeline specifying the first intermediate output to be processed as input to the second subcommand, wherein in this case, the processing routine further comprises instantiating a second virtual processing entity within the computer network, and the triggering of an execution of the input command using the first virtual processing entity comprises: triggering an execution of the first subcommand by the first virtual processing entity; causing a transfer of the first intermediate output from the first virtual processing entity to the second virtual processing entity; triggering a processing of the first intermediate output as input to the second subcommand by execution of the second subcommand using the second virtual processing entity.

This may have the advantage of enabling distributed processing of a pipelined sequence of subcommands. In particular, the approach may be applied recursively: For instance, the second subcommand may in turn be a pipeline of a second sub-subcommand and a third subcommand, where the second sub-subcommand may be processed by the second PE and the third subcommand may be processed using an additionally instantiated third PE; and so on. In a job of sequential distributed processing, the LM may receive a notification that the execution of one portion by one virtual processing entity is finished, and in response thereto, may trigger an execution of a next portion if the input command requires a sequential execution. The resulting output may be pushed to the LM or may be fetched by the LM from an SE (see below) or from the last PE(s) in the sequence. Alternatively or additionally, sequential execution may be implemented using inter-entity communication.

In an example, the LM may instantiate and configure a downstream PE to wait for an execution by an upstream PE to finish. The upstream PE may then notify the downstream PE when its portion of execution is finished. The intermediate output generated by the upstream execution may then be pushed to the downstream PE (e.g., together with the finish notification), or the downstream PE may pull the intermediate output from the upstream PE or from a shared SE. Alternatively, provisioning of a waiting downstream PE may be avoided by the LM instantiating the downstream PE not before receiving the finish notification from the upstream PE.

In an example, the processing routine further comprises instantiating a virtual storage entity within the computer network, the causing of a transfer of the first intermediate output from the first virtual processing entity to the second virtual processing entity comprising: configuring the first virtual processing entity to write the first intermediate output to the virtual storage entity; configuring the second virtual processing entity to read the first intermediate output from the virtual storage entity.

This may provide a persistence layer that is decoupled from the pipe-based transport mechanism. In particular, the virtual storage entity (storage entity, SE) may be used as a shared storage between different PEs participating in the distributed execution of the input command. This may reduce the effort of configuring the PEs during instantiation for inter-entity communication. Instead, it may be sufficient to mount the SE to each PE intended to use the SE as a shared resource. A downstream PE (the first virtual processing entity) may then read the intermediate output generated by the processing of its respective upstream portion of the input command from its respective storage location on the SE. Configuration of the downstream PE (the second virtual processing entity) may include defining the output path of the upstream PE as the path for retrieving the input data for the portion of the input command to be processed by the downstream PE.

An example relates to the case that the execution of the input command using the first virtual processing entity comprises an independent processing of multiple input portions, wherein, in this case, the processing routine further comprises: instantiating a plurality of virtual processing entities within the computer network; triggering a parallel processing of the multiple input portions using the plurality of virtual processing entities.

This may enable a distributed parallel processing of the input command or portions thereof. In a preferred example, each input portion to be processed independently may be processed by one virtual processing entity of the plurality of virtual processing entities. However, this does not necessarily have to be the case if, for instance, the processing load for different input portions is inhomogeneous. If the workload to be caused by different input portions can be estimated before execution, it may therefore be more feasible in this case to have a high-workload input portion be processed by one PE, while one or more other PE(s) may each process multiple low-workload input portions. A decision by the LM whether to apply parallel execution or not may require analysing the input data for possible interdependencies. If the parallel processing portion itself is a portion of a processing sequence as described before, the input data may be the intermediate output of one or more preceding PE(s), and instantiating a number of parallel PEs may be based on a result of the analysis, e.g., the number of parallel PEs may correspond or be equal to the number of output portions generated by the upstream PE(s).

In an example, the processing routine further comprises instantiating a virtual storage entity, the triggering of an execution of the input command using the first virtual processing entity comprising causing the first virtual processing entity to execute a job process incorporating a portion of the execution of the input command using the first virtual processing entity, the instantiation of the first virtual processing entity comprising configuring the first virtual processing entity to provide the job process with at least one of a read access to the virtual storage entity, and a write access to the virtual storage entity.

This may provide a persistence layer for input data, output data, and/or computer-executable code involved in the distributed processing of the input command. In sequential processing, downstream PEs may obtain a lower barrier for access to intermediate output generated by upstream PEs in the computer network. A virtual storage entity (SE) may also enable a smaller initial memory footprint of the PEs and may enable a temporal decoupling of the provisioning of code to be executed and/or input data to be processed from the time of instantiation of the individual PEs participating in the execution of the input command. Configuration of a PE to use a specific location on the SE as a source of code and/or input data may be reduced to mounting the SE to a filesystem of the PE and setting the respective storage path as a working directory and/or passing the directory to the process running on the individual PE for processing the PE's respective portion of the input command. An advantage of providing an SE as a persistence layer may include the possibility to have data (input, output, code) available to the LM independent of the status (including possible termination) of the PEs.

In an example, the processing routine further comprises writing to the virtual storage entity job input data to be used as input to the job process, the instantiation of the first virtual processing entity comprising: configuring the first virtual processing entity to provide the job process with a read access to the virtual storage entity; configuring the first virtual processing entity to provide the job input data as input to the job process by reading the job input data from the virtual storage entity.

The job process may be understood as any process running on the individual PE for processing the PE's respective portion of the input command. Read access to job input data may enable running the PE with a smaller memory footprint as the PE may perform a random access to the SE as needed during the execution of the job process without having to preload the full amount of the job input data. In contrast, code to be executed by or as the job process may be stored by the PE itself instead; while (intermediate or resulting) output may instead be transferred to the LM or the next downstream PE.

In an example, the execution of the job process results in a generation of job output data, the instantiation of the first virtual processing entity comprising: configuring the first virtual processing entity to provide the job process with a write access to the virtual storage entity; configuring the first virtual processing entity to store the job output data by writing the job output data to the virtual storage entity.

This may facilitate collaboration between multiple PEs, may enable the LM (or a user of the LM) to make further use of any intermediate output, and may make the accessibility of the job output data persistent and independent of the status of the PE that generated them.

In an example, the execution of the job process comprises executing a job code, the processing routine further comprising writing the job code to the virtual storage entity, the instantiation of the first virtual processing entity comprising configuring the first virtual processing entity to: obtain a read access to the virtual storage entity; start the job process by performing a job start routine comprising reading the job code from the virtual storage entity; execute the job process by performing a job execution routine comprising executing the job code read from the virtual storage entity.

This may enable a PE to process code that is not pre-installed during its instantiation, and may therefore enable starting the PE with a smaller initial memory footprint. Moreover, the times of code provisioning and PE instantiation may be decoupled.

In an example, the processing routine further comprises terminating the virtual storage entity in response to the receipt of the resulting output. This may prevent excessive memory consumption by data that may be not needed at a storage location separate from the LM after the receipt of the resulting output. In an example, the termination of the SE is delayed by a time interval (e.g., 10 days after retrieval of the resulting output) specified in the policy described herein.

In an example, the processing routine further comprises mounting the virtual storage entity to a filesystem of the computing device. As a user or process of the LM may not know the exact location of a newly instantiated storage entity in the computer network, this may facilitate an access, by a process or user of the LM to data stored by the SE, that is independent of the distributed execution of the input command itself.

In an example, the processing routine further comprises terminating the first virtual processing entity in response to the receipt of the resulting output. In another example, the processing routine further comprises terminating the first virtual processing entity in response to a successful receipt of output data generated by the first virtual processing entity while participating in the execution of the input command using the first virtual processing entity. In both examples, resources of the computer network that are not used anymore after the execution of the input command using the first virtual processing entity may be freed in this way in a timely manner. If a storage entity is also instantiated, it may be beneficial to keep (i.e., to not terminate) the storage entity after termination of the PE, which may yield a more pronounced decoupling of the persistence layer from the execution. In another example, the storage entity is terminated together with the last active processing entity, which may free up memory resources in addition.

In an example, the execution of the input command using the first virtual processing entity comprises an execution of a job code by the first virtual processing entity, the instantiation of the first virtual processing entity comprising transferring the job code to the first virtual processing entity. This may enable to instantiate different PEs as generic processing entities that do not have to be tailored to requirements of particular processing portions.

In an example, the performance of the processing routine is transparent to a user of the computing device. Transparency to a user may mean that the user may be unable to tell if the input command is executed locally or not unless the user actively monitors parameters of the execution. This may have the advantage that no reconfiguration of the LM and/or no reprogramming of the input command or the code to be executed may be necessary. It may also provide a user experience with a maximally reduced barrier to distributed processing. In the following, more specific examples are given that may facilitate providing a transparent user experience.

In an example, the execution of the input command using the first virtual processing entity comprises executing a job process by the first virtual processing entity, the processing routine further comprising: generating a local process identifier on the computing device; linking the local process identifier to a job process identifier generated by the first virtual processing entity to represent the job process, the linking comprising making job process metadata associated with the job process available to the computing device using the local process identifier.

This may facilitate monitoring of the execution of the job process using tools like the “top” command in a Unix OS, or similar. Depending on the information forwarding mechanism between a PE and the LM (e.g., using socat as described above), it may be possible to create a logical link (e.g., a filesystem link in a Unix OS pointing to a file in /roc) that forwards the local process identifier (local PID) to the desired job process identifier (job PID) on the PE. This may increase transparency of the remote execution as remote processes may appear as local processes in monitoring tools like top.

In an example, the input command is configured to direct the resulting output to an intended data stream of the computing device, the execution of the input command using the first virtual processing entity comprising an execution of a portion of the input command by a last virtual processing entity instantiated within the computer network by the computing device performing the processing routine, the execution of the portion of the input command by the last virtual processing entity resulting in a portion of the resulting output, the instantiation of the last virtual processing entity comprising configuring the last virtual processing entity and the computing device to automatically relay the portion of the resulting output from the last virtual processing entity to the intended data stream via the computer network.

This may provide a “push” mechanism making the resulting output (portion) available to the LM with a minimum of delay and without a need for the LM to query the resulting output or for the PE to send a completion notification message to the LM. This may provide for a more integrated user experience, and thus, to an increased transparency of the distributed execution. It is noted again that the last PE may be identical to the first virtual processing entity if the first virtual processing entity is the only processing entity participating in the execution of the input command using the first virtual processing entity.

In an example, the processing routine is started by an aliased command called by the trigger signal. This may render unnecessary to call the processing routine using explicit means such as a decorator or a wrapper script added to the actual input command or subcommand to be called. While decorators, wrappers, and the like may still be needed to start the processing routine, their explicit calls may be camouflaged by aliasing these calls, e.g., using the “alias” command in Unix shells, an environment variable defining the decorator/wrapper call, or the like. This may also increase transparency for a user as it may become unnecessary to change the input command for all (sub)commands covered by the alias. While a wrapper may be more useful to define custom configurations and/or criteria for distributed execution for each particular wrapped (sub)command, a decorator may be used to apply generic configurations, or may contain a case script to apply command-specific rules.

In an example, the processing routine further comprises determining, based on the input command, an optimal configuration of the first virtual processing entity for the execution of the input command using the first virtual processing entity, the instantiation of the first virtual processing entity comprising applying the optimal configuration to the first virtual processing entity. This may increase performance of the optimized PE when executing its respective portion of the input command. The optimal configuration may specify parameters that set a particular property or function of the first virtual processing entity, including, without limitation, a machine type, CPU architecture, OS, filesystem, permissions, etc. For instance, the optimal configuration may redefine particular emulated machine parameters such as “vsi.machine.type: cpu-64vCPU” and “vsi.cpu.arch: ARM” overriding possible policy-inherited, default instantiation parameters such as “vsi.machine.type: balanced-32GB” and “vsi.cpu.arch: x86”, respectively.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as processing 150 of an input command using conditional distributed execution. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

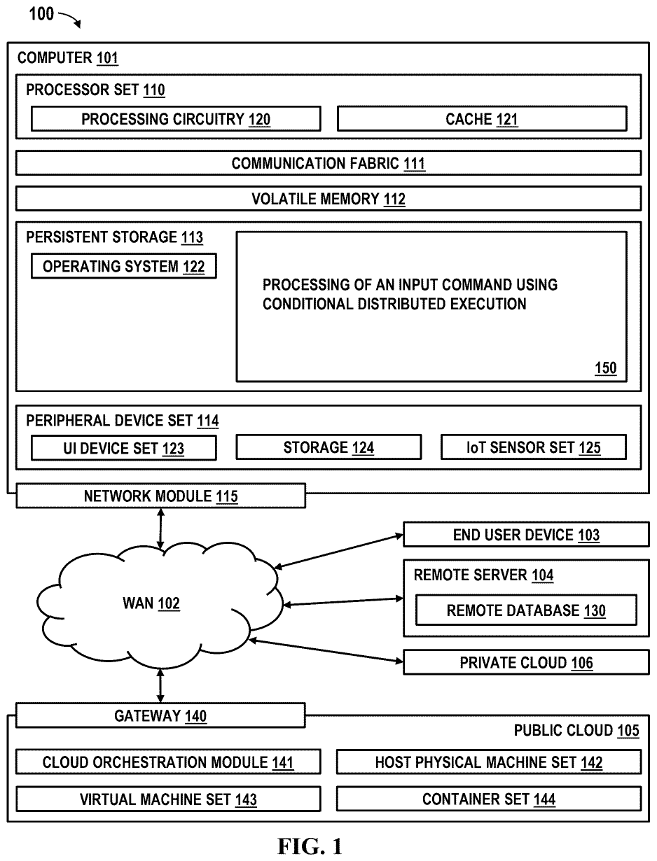

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

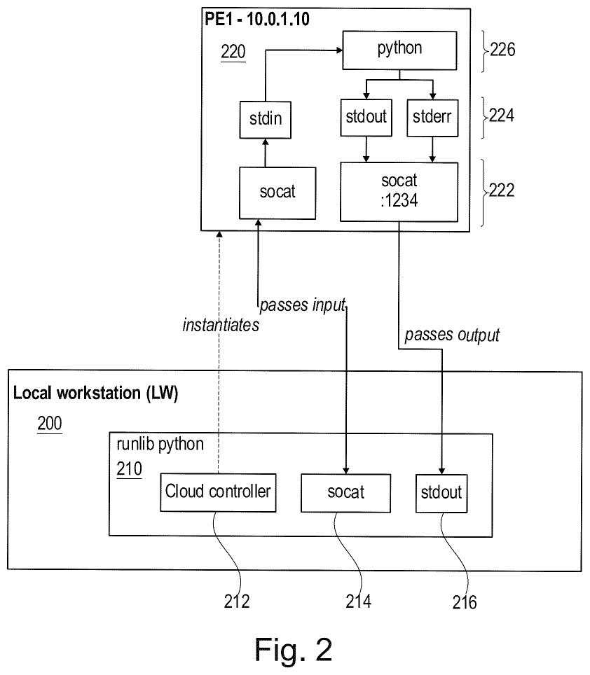

FIG. 2 is a block diagram showing an exemplary setup of entities of a computer network that may be involved in a processing of an input command using distributed execution. The setup comprises a computing device 200 (also referred to as local workstation, LW) that is configured for exchanging information with a computer network. WAN 102 and public cloud 105 may be considered as components of the computer network. The computing device 200 operates a support component 210 implementing support for conditional distributed execution as described herein. By way of example only, support component 210 is shown in the drawing as a runtime library called “runlib”, but it is understood that many other ways of providing support for conditional distributed execution, including but not limited to running a daemon or service on the LW 200, may be possible as well. Furthermore, support component 210 is exemplarily shown as an element of runlib providing dedicated support for a call to the program “Python”.

On a command-line interface (CLI), Python may be represented by the name of an executable to be called explicitly (e.g., “python3”), prepended by runlib as a decorator to ensure that the processing routine is triggered upon receipt of the trigger signal. A possible CLI-based input command may then look like “runlib python3 my-script.py” and may be made transparent by a configuration set up using a CLI command like “alias python3=runlib python3”, such that a CLI user may issue the input command as “python3 my-script.py”. It is understood that any examples referring to a CLI-based input command are given herein for the sole purpose of illustration, and that an input command may encompass many other forms, including non-CLI-based commands.

The call to runlib triggered by a receipt of the trigger signal may start a cloud controller component 212 that is executed by the LW 200 to perform the processing routine. If the cloud controller 212 determines that the input command fulfils a criterion for being processed using distributed execution, it may instantiate a new virtual processing entity 220 (the first virtual processing entity, PE1) on a service provider's hardware that can be reached via the computer network. Upon instantiation, the cloud controller may configure PE1 220 to contain required or recommended elements of configuration.

In the example shown, PE1 220 may be configured to deploy socat as an information interface 222 enabling enhanced information exchange with LW 200, and on the opposite side, LW 200 deploys socat as an information interface 214 enabling enhanced information exchange with PE1 220. The information interfaces 214, 222 may enable to forward information on the level of the data handling structures 224 on the PE side and 216 on the LW side. Although only standard data streams stdin, stdout, and stderr are shown as examples of the data handling structures 216, 224, it is understood that various other data handling structures can be used as well.

Using the information interfaces 214, 222, the LW 200 may provide the PE 220 with input, which may comprise input data to be consumed during the execution of the input command. In an example, the input data is limited to data that the PE 220 cannot retrieve from the computer network by itself. Optionally, unless already provided by the PE 220, the transmitted input may further comprise executable code 226 to be executed by the PE 220 for performing the execution of the input command, which may include executable files and/or a runtime environment, for instance. In the depicted example, Python is shown as a portion of executable code 226 available on the PE 220.

The LM 200 may then trigger the execution of the input command by the PE1 220. Upon execution, the input data received from the LM 200 via the computer network may be forwarded to the executable code 226 by the data handling structures 224 (e.g., stdin). In the course of the execution, PE1 220 runs one or more processes and/or threads processing the executable code 226 and the input data, which may result in a generation of output data that may be handled by appropriate data handling structure(s) 224 (e.g., stdout, stderr). In the depicted example, PE1 may be configured to forward data received by the data handling structures 224 in response to the execution via the information interfaces 222, 214 and the computer network to the corresponding data handling structure 216 of the LM 200 (e.g., stdout). In this manner, the usage of socat may effect a combination of the method steps of receiving and providing the resulting output by the computing device 200.

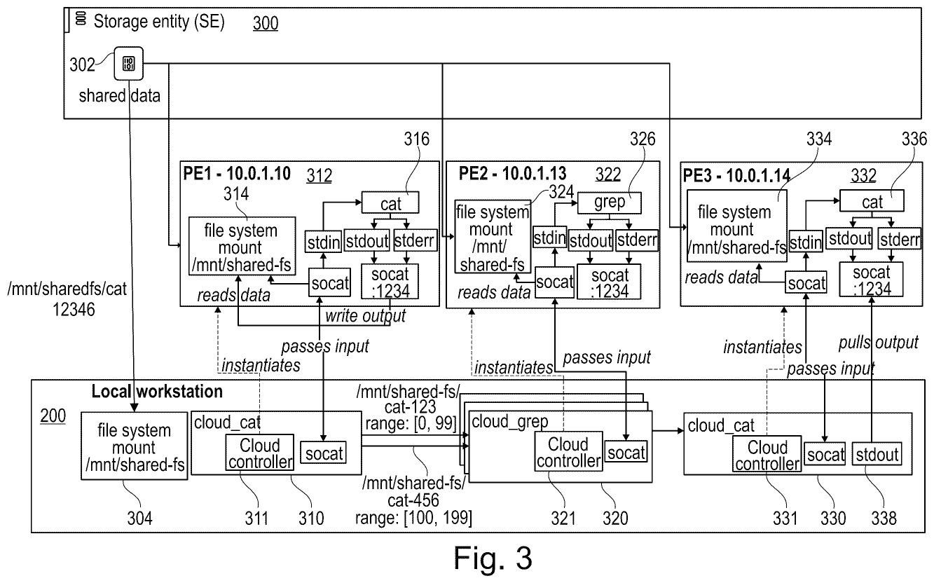

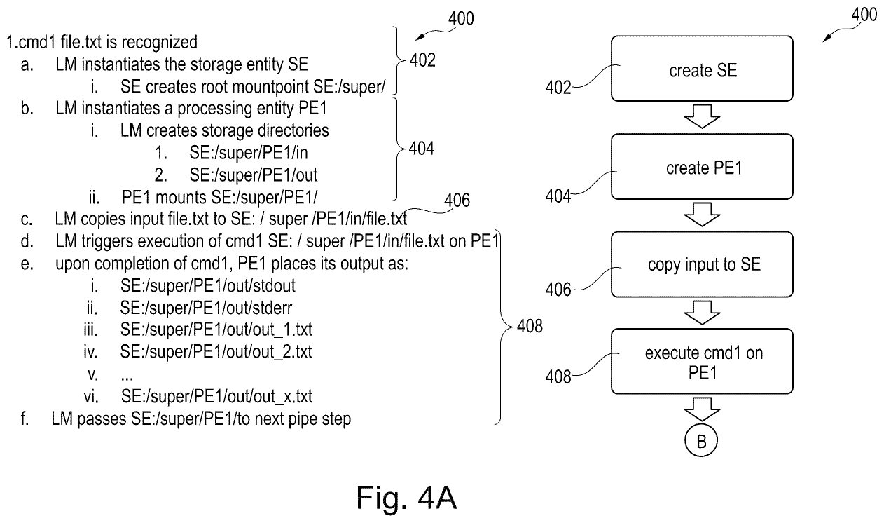

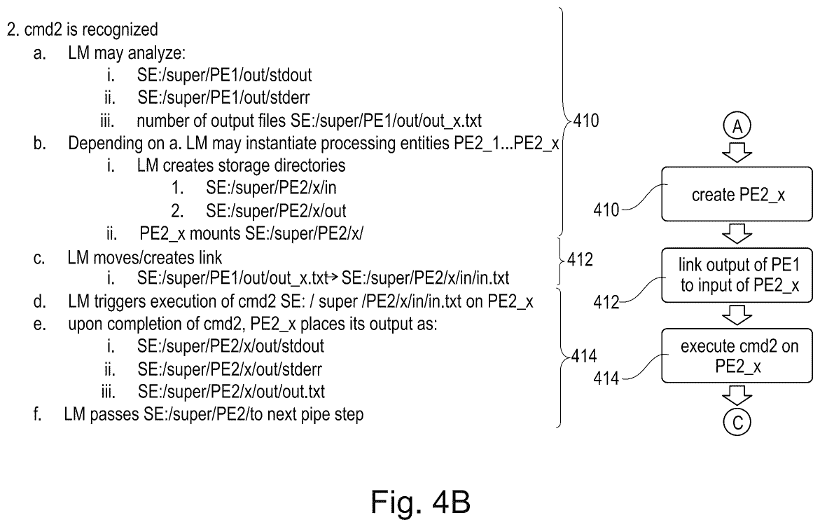

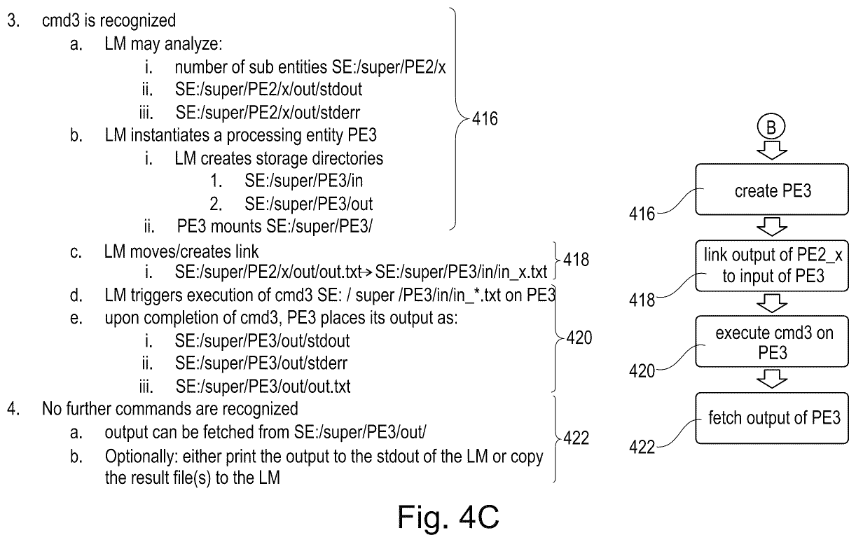

FIG. 3 is a block diagram showing entities of a computer network involved in a sequential processing of a pipeline input command using distributed sequential and parallel execution. The functionality of the computing device 200 (local workstation, LW, or local machine, LM) is discussed for the case of an exemplary input command having the basic structure “cmd1 file.txt|cmd2|cmd3”. The example assumes that cmd1 (e.g., cat) extracts information from an input file (file.txt) and creates a set of output files out_x.txt, which is then processed through cmd2 (e.g., grep) in a distributed way with cmd3 (e.g., cat) merging the results. In the example of FIG. 3, a storage entity 300 (SE) is used to supplement the process. In the following, FIG. 3 is discussed together with FIG. 4, which shows a sequence of drawings 4A to 4C showing steps of a possible workflow 400 that may effect a processing of the exemplary pipeline input command given above at two different levels of detail, namely as a block sequence to the right and as a more fine-grained pseudocode sequence to the left. FIGS. 3 and 4 may give an insightful example of how the present method may enable a distributed execution of commands with a remote depth greater than 1.

The LW 200 may receive a trigger signal causing the LW 200 to process the input command. The input command comprises a first subcommand “cmd1 file.txt” separated from a second subcommand by a pipeline character “|”. Execution of the first subcommand by the LM 200, however, may not start the specified executable “cmd1”, but an aliased wrapper script 310 “cloud_cmd1” performing the processing routine for cmd1 (in the drawing denoted “cloud_cat” for the case that cmd1 is the “cat” command).

The wrapper 310 may call a cloud controller module 311 similar to cloud controller module 212 shown in FIG. 2. The cloud controller 311 may determine whether the first subcommand shall be executed using distributed execution, taking into account, e.g., a policy specifying predefined generic rules that are valid for all commands, and/or rules specific to the command cmd1, and/or rules specific to the operation step “cmd1 file.txt”. Upon determining that the first subcommand shall be executed using distributed execution, the cloud controller module 311 may instantiate 402 the SE 300. SE 300 may start up by creating a root mountpoint 302 SE:/super/ that may be used by the LM 200 and any SEs configured for using the SE 300 as well. The cloud controller 311 may generate a mount 304 of the mountpoint 302 in a file system of LW 200.

In response, the cloud controller 311 may newly instantiate 404 a first virtual processing entity PE1 312. At the SE 300, cloud controller 311 may generate new storage directories “SE:/super/PE1/in” for storing input to PE1 312, and “SE:/super/PE1/out” for storing output generated by PE1 312 executing cmd1. In order to do so, cloud controller 311 may generate a mount 314 of the mountpoint 302 in a filesystem of PE1 312 and configure PE1 for using these storage locations as input and output directories, respectively. For further preparation, cloud controller 311 may copy 406 the input data file.txt to the input directory SE:/super/PE1/in for PE1312 at SE 300.

Cloud controller 311 may then trigger an execution 408 of the first subcommand “cmd1 file.txt” by PE1 312. This may cause PE1 312 to run a process 316 performing the execution of the first subcommand using the input data in the input directory. As configured by cloud controller 311, PE1 312 may write its output to its output directory “SE:/super/PE1/out”. In the depicted example, the output may comprise output data directed to the standard output stream stdout written to a buffer file SE:/super/PE1/out/stdout, output data directed to the standard error stream stderr written to a buffer file SE:/super/PE1/out/stderr, and a plurality of x output files out_1.txt, out_2.txt, . . . , out_x.txt. Upon completion of the execution 408, PE1 312 may notify the cloud controller 311 about the completion using an information interface mechanism analogous to information interfaces 222, 214 shown in FIG. 2. Cloud controller module 311 may then pass the control flow back to the process running on LM 200 executing the input command.

LM 200 may proceed with executing the input command further, determining that the second subcommand comprises a second sub-subcommand “cmd2” separated from a third subcommand by a pipeline character “|”. Execution of the second sub-subcommand by the LM 200, however, may not start the specified executable “cmd2”, but an aliased wrapper script 320 “cloud_cmd2” performing the processing routine for cmd2 (in the drawing denoted “cloud_grep” for the case that cmd2 is the “grep” command). The wrapper 320 may call a cloud controller module 321 similar to cloud controller module 311. The cloud controller 321 may determine whether the second sub-subcommand shall be executed using distributed execution, taking into account, e.g., a policy specifying predefined generic rules that are valid for all commands, and/or rules specific to the command cmd2.

Upon determining that the second sub-subcommand shall be executed using distributed execution, the cloud controller module 321 may analyse the output in PEI's output directory on the SE 300, determining that the cmdl process 316 generated a plurality of x output files out_1.txt, . . . , out_x.txt that are each to be processed individually using cmd2. Cloud controller 321 may recognize this as a case permitting parallel distributed execution, and in response, the cloud controller 321 may newly instantiate 410 a plurality of x second virtual processing entities 322 PE2_1, PE2_2, . . . , PE2_x. At the SE 300, cloud controller 321 may generate new storage directories “SE:/super/PE2/k/in” for storing input to each PE2_k 322, 1≤k≤x, and “SE:/super/PE2/k/out” for storing output generated by PE2_k 322 executing cmd2 with its respective input. In order to do so, cloud controller 321 may generate a mount 324 of the mountpoint 302 in a filesystem of each PE2_k 322 and configure each PE2_k for using these storage locations as input and output directories, respectively. To allow the PE2_k 322 to use the output files provided by PEI as input, cloud controller 321 may provide 412 the respective output file(s) to each PE2_k's input directory, e.g., by copying or moving each file SE:/super/PE1/out/out_k.txt to SE:/super/PE2/k/in/, optionally renaming it, or by creating a link (e.g., a symlink) pointing from SE:/super/PE2/k/in/in.txt to SE:/super/PE1/out/out_k.txt.

The cloud controller 321 may then trigger an execution 414 of the second sub-subcommand cmd2 by each PE2_k 322. This may cause each PE2_k 322 to run a process 326 performing the execution of the second sub-subcommand using the input data in its respective input directory. As configured by cloud controller 321, each PE2_k 322 may write its output to its respective output directory “SE:/super/PE2/k/out”. In the depicted example, each PE2_k's output may comprise output data directed to the standard output stream stdout written to a buffer file SE:/super/PE2/x/out/stdout, output data directed to the standard error stream stderr written to a buffer file SE:/super/PE2/x/out/stderr, and one output file SE:/super/PE2/x/out/out.txt. Upon completion of the execution 414, each PE2_k 322 may notify cloud controller 321 about the completion using an information interface mechanism analogous to information interfaces 222, 214 shown in FIG. 2. Cloud controller module 321 may then pass the control flow back to the process running on LM 200 executing the input command.

LM 200 may proceed with executing the input command further, determining that the third subcommand comprises a third sub-subcommand “cmd3”, and that the third subcommand is the final subcommand in the pipeline sequence. Execution of the third sub-subcommand by the LM 200, however, may not start the specified executable “cmd 3”, but an aliased wrapper script 330 “cloud_cmd3” performing the processing routine for cmd3 (in the drawing denoted “cloud_cat” for the case that cmd3 is the “cat” command). The wrapper 330 may call a cloud controller module 331 similar to cloud controller module 311. The cloud controller 331 may determine whether the second sub-subcommand shall be executed using distributed execution, taking into account, e.g., a policy specifying predefined generic rules that are valid for all commands, and/or rules specific to the command cmd2.

Upon determining that the second sub-subcommand shall be executed using distributed execution, the cloud controller module 331 may analyse the output in the PE2_ks'output directories on the SE 300, determining that each cmd2 process 316 generated a single output file out.txt to be processed as a portion of input to cmd3. Cloud controller 331 may recognize this as a case where the processing of multiple input files results in the generation of a single output file, and in response, the cloud controller 331 may newly instantiate 416 a third virtual processing entity 332 PE3. At the SE 300, cloud controller 331 may generate new storage directories “SE:/super/PE3/in” for storing input to PE3 332, and “SE:/super/PE3/out” for storing output generated by PE3 332 executing cmd3 with the plurality of input files SE:/super/PE2/x/out/out.txt. In order to do so, cloud controller 331 may generate a mount 334 of the mountpoint 302 in a filesystem of PE 3 332 and configure each PE3 for using these storage locations as input and output directories, respectively. To allow the PE 3 332 to use the output files provided by each PE2_k as input, cloud controller 331 may provide 418 the respective output files to PE3's input directory, e.g., by copying or moving each file SE:/super/PE2/k/out/out.txt to SE:/super/PE3/in/, appropriately renaming each SE:/super/PE2/k/out/out.txt to SE:/super/PE3/in/in_k.txt, for instance, or by creating respective links (e.g., symlinks) pointing from SE:/super/PE3/in/in_k.txt to SE:/super/PE2/k/out/out.txt.

The cloud controller 331 may then trigger an execution 420 of the third sub-subcommand cmd3 by PE3 332. This may cause PE3 332 to run a process 336 performing the execution of the third sub-subcommand using the input data in its input directory. As configured by cloud controller 331, PE3 332 may write its output to its output directory “SE:/super/PE3/out”. In the depicted example, each PE3's output may comprise output data directed to the standard output stream stdout written to a buffer file SE:/super/PE3/out/stdout, output data directed to the standard error stream stderr written to a buffer file SE:/super/PE3/out/stderr, and one output file SE:/super/PE3/out/out.txt (the resulting output).

Upon completion of the execution 420, PE3 332 may notify cloud controller 331 about the completion using an information interface mechanism analogous to information interfaces 222, 214 shown in FIG. 2. Having determined that the third subcommand was the last sequential subcommand of the input command (PE3 thus being the last virtual processing entity), cloud controller module may continue by obtaining 422 the resulting output, e.g., by reading the output generated by PE3 from the SE 300, and providing the output to all applicable data handlers 338. In the example, the resulting output SE:/super/PE3/out/out.txt may be passed on to the standard output stdout of the LM 200 and/or copied to the filesystem of LM 200. Cloud controller module 331 may then pass the control flow back to the process running on LM 200 executing the input command, which may terminate as the processing of the input command has been completed.

It is noted that the example discussed along FIGS. 3 and 4 may allow for various variations. For instance, it may be possible to configure some or all subsequent PEs to obtain the output of an upstream PE directly from the respective upstream PE. If all PEs are configured this way, it may be possible to perform the execution of the input command without using an SE 300 at all. In this case, the input data may be passed directly to the first PE in the sequence, and the resulting output may be obtained directly from the last PE in the sequence. Furthermore, it may be possible to configure some or all PEs to automatically forward data received by their respective internal data handlers to the LM 200 using the respective information interface (e.g., socat). For instance, automatic forwarding of stdout and/or stderr may allow the LW 200 to receive information about the processing of the input command in near real time. This may not exclude a configuration of the PEs where the information received by internal data handlers of the PEs is copied to an SE 300, such that the SE 300 may store this information as stream backups for later use. In addition, it may be possible to determine (e.g., by the first cloud controller module 311) whether the input command as a whole shall be processed by distributed processing. This may render unnecessary to repeat this determination for each subcommand by each subsequent cloud controller module (e.g., cloud controllers 321, 331) anew. This may also avoid possibly network-inefficient scenarios where an initial portion of the input command is processed in a distributed manner, the intermediate results of which being transferred to the LM 200 for local execution of a next portion of the input command, then downstream intermediate results being transferred back to the computer network for a second round of distributed execution of a further portion of the input command, etc.

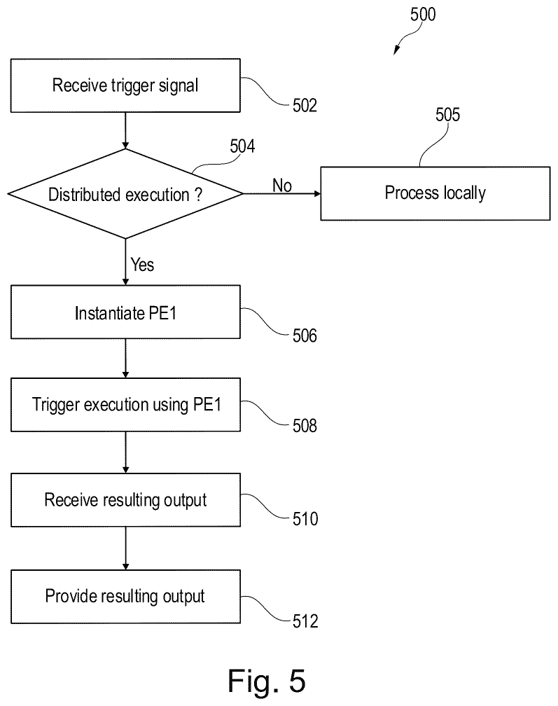

FIG. 5 is a flow diagram depicting possible steps of a method 500 of processing an input command using conditional distributed execution. The method 500 may include receiving 502 a trigger signal for triggering execution of an input command by a computing device 200 that is configured for exchanging information with a computer network. The computing device 200 may then determine 504 whether the input command, or a portion of it, shall be executed in a distributed manner. If the determination 504 results in that the input command or its respective portion shall not be executed in a distributed manner, method 500 may proceed by triggering a local execution 505 of the input command by the computing device 200. If the determination 504 results in that the input command or its respective portion shall be executed in a distributed manner, method 500 may proceed by instantiating 506 a first virtual processing entity 220 in the computer network; triggering 508 an execution of the input command (portion) using the first virtual processing entity 220; receiving 510 a resulting output generated by the execution of the input command using the first virtual processing entity 220 via the computer network; and providing the resulting output 512 to data handlers onboard the computing device 200 that would have received a portion of the resulting output in response to a hypothetical execution of the input command by the computing device 200.

In the following, examples illustrating notions of the invention will be described again by a list of clauses highlighting several possible, non-exclusive combinations of features described herein:
Clause 1, a method of processing an input command using a computing device configured for exchanging information with a computer network, the method comprising, by the computing device: in response to receiving a trigger signal configured to cause the computing device to process the input command, performing a processing routine comprising: in response to determining that the input command shall be processed using distributed execution: instantiating a first virtual processing entity within the computer network; triggering an execution of the input command using the first virtual processing entity, the execution resulting in a resulting output; receiving the resulting output from the computer network; providing the resulting output.

Clause 2 the method of clause 1, wherein, in case the input command comprises: a first subcommand, wherein execution of the first subcommand results in a first intermediate output; a second subcommand, wherein execution of the second subcommand results in a second intermediate output; and a pipeline specifying the first intermediate output to be processed as input to the second subcommand, the processing routine further comprises instantiating a second virtual processing entity within the computer network, and the triggering of an execution of the input command using the first virtual processing entity comprises: triggering an execution of the first subcommand by the first virtual processing entity; causing a transfer of the first intermediate output from the first virtual processing entity to the second virtual processing entity; triggering a processing of the first intermediate output as input to the second subcommand by execution of the second subcommand using the second virtual processing entity.

Clause 3 the method of clause 2, the processing routine further comprising instantiating a virtual storage entity within the computer network, the causing of a transfer of the first intermediate output from the first virtual processing entity to the second virtual processing entity comprising: configuring the first virtual processing entity to write the first intermediate output to the virtual storage entity; configuring the second virtual processing entity to read the first intermediate output from the virtual storage entity.

Clause 4 the method of any of the preceding clauses, wherein, in case the execution of the input command using the first virtual processing entity comprises an independent processing of multiple input portions, the processing routine further comprises: instantiating a plurality of virtual processing entities within the computer network; triggering a parallel processing of the multiple input portions using the plurality of virtual processing entities.

Clause 5 the method of any of the preceding clauses, the processing routine further comprising instantiating a virtual storage entity, the triggering of an execution of the input command using the first virtual processing entity comprising causing the first virtual processing entity to execute a job process incorporating a portion of the execution of the input command using the first virtual processing entity, the instantiation of the first virtual processing entity comprising configuring the first virtual processing entity to provide the job process with at least one of a read access to the virtual storage entity, and a write access to the virtual storage entity.

Clause 6 the method of clause 5, the processing routine further comprising writing to the virtual storage entity job input data to be used as input to the job process, the instantiation of the first virtual processing entity comprising: configuring the first virtual processing entity to provide the job process with a read access to the virtual storage entity; configuring the first virtual processing entity to provide the job input data as input to the job process by reading the job input data from the virtual storage entity.

Clause 7 the method of clause 5 or 6, the execution of the job process resulting in a generation of job output data, the instantiation of the first virtual processing entity comprising: configuring the first virtual processing entity to provide the job process with a write access to the virtual storage entity; configuring the first virtual processing entity to store the job output data by writing the job output data to the virtual storage entity.

Clause 8 the method of clause 5, 6, or 7, the execution of the job process comprising executing a job code, the processing routine further comprising writing the job code to the virtual storage entity, the instantiation of the first virtual processing entity comprising configuring the first virtual processing entity to: obtain a read access to the virtual storage entity; start the job process by performing a job start routine comprising reading the job code from the virtual storage entity; execute the job process by performing a job execution routine comprising executing the job code read from the virtual storage entity.

Clause 9 the method of any one of clauses 5 to 8, the processing routine further comprising terminating the virtual storage entity in response to the receipt of the resulting output.

Clause 10 the method of any one of clauses 5 to 9, the processing routine further comprising mounting the virtual storage entity to a filesystem of the computing device.

Clause 11 the method of any of the preceding clauses, the processing routine further comprising terminating the first virtual processing entity in response to the receipt of the resulting output.

Clause 12 the method of any of the preceding clauses, the execution of the input command using the first virtual processing entity comprising an execution of a job code by the first virtual processing entity, the instantiation of the first virtual processing entity comprising transferring the job code to the first virtual processing entity.

Clause 13 the method of any of the preceding clauses, the performance of the processing routine being transparent to a user of the computing device.

Clause 14 the method of clause 13, the execution of the input command using the first virtual processing entity comprising executing a job process by the first virtual processing entity, the processing routine further comprising: generating a local process identifier on the computing device; linking the local process identifier to a job process identifier generated by the first virtual processing entity to represent the job process, the linking comprising making job process metadata associated with the job process available to the computing device using the local process identifier.

Clause 15 the method of clause 13 or 14, the input command being configured to direct the resulting output to an intended data stream of the computing device, the execution of the input command using the first virtual processing entity comprising an execution of a portion of the input command by a last virtual processing entity instantiated within the computer network by the computing device performing the processing routine, the execution of the portion of the input command by the last virtual processing entity resulting in a portion of the resulting output, the instantiation of the last virtual processing entity comprising configuring the last virtual processing entity and the computing device to automatically relay the portion of the resulting output from the last virtual processing entity to the intended data stream via the computer network.

Clause 16 the method of clause 13, 14, or 15, the processing routine being started by an aliased command called by the trigger signal.

Clause 17 the method of any of the preceding clauses, the processing routine further comprising determining, based on the input command, an optimal configuration of the first virtual processing entity for the execution of the input command using the first virtual processing entity, the instantiation of the first virtual processing entity comprising applying the optimal configuration to the first virtual processing entity.

Clause 18 a computing device comprising a processor and a memory and being configured for exchanging information with a computer network, the memory storing program instructions which, when executed by the processor, cause the computing device to perform a method of processing an input command, the method comprising: in response to receiving a trigger signal configured to cause the computing device to process the input command, performing a processing routine comprising: in response to determining that the input command shall be processed using distributed execution: instantiating a first virtual processing entity within the computer network; triggering an execution of the input command using the first virtual processing entity, the execution resulting in a resulting output; receiving the resulting output from the computer network; providing the resulting output.

Clause 19 a computer program product comprising a computer readable storage medium having program instructions embodied therewith, the program instructions being executable by a processor of a computing device configured for exchanging information with a computer network, wherein execution of the program instructions by the processor causes the computing device to perform a method of processing an input command, the method comprising: in response to receiving a trigger signal configured to cause the computing device to process the input command, performing a processing routine comprising: in response to determining that the input command shall be processed using distributed execution: instantiating a first virtual processing entity within the computer network; triggering an execution of the input command using the first virtual processing entity, the execution resulting in a resulting output; receiving the resulting output from the computer network; providing the resulting output.

What is claimed is:

1. A method of processing an input command using a computing device configured for exchanging information with a computer network, the method comprising, by the computing device:
in response to receiving a trigger signal configured to cause the computing device to process the input command, performing a processing routine comprising:
in response to determining that the input command shall be processed using distributed execution:
instantiating a first virtual processing entity within the computer network;
triggering an execution of the input command using the first virtual processing entity, the execution resulting in a resulting output;
receiving the resulting output from the computer network; and
providing the resulting output.

2. The method of claim 1, wherein, in case the input command comprises:
a first subcommand, wherein execution of the first subcommand results in a first intermediate output;
a second subcommand, wherein execution of the second subcommand results in a second intermediate output; and
a pipeline specifying the first intermediate output to be processed as input to the second subcommand,
the processing routine further comprises instantiating a second virtual processing entity within the computer network, and the triggering of an execution of the input command using the first virtual processing entity comprises:
triggering an execution of the first subcommand by the first virtual processing entity;
causing a transfer of the first intermediate output from the first virtual processing entity to the second virtual processing entity; and
triggering a processing of the first intermediate output as input to the second subcommand by execution of the second subcommand using the second virtual processing entity.

3. The method of claim 2, the processing routine further comprising instantiating a virtual storage entity within the computer network, the causing of a transfer of the first intermediate output from the first virtual processing entity to the second virtual processing entity comprising:
configuring the first virtual processing entity to write the first intermediate output to the virtual storage entity; and
configuring the second virtual processing entity to read the first intermediate output from the virtual storage entity.

4. The method of claim 1, wherein, in case the execution of the input command using the first virtual processing entity comprises an independent processing of multiple input portions, the processing routine further comprises:
instantiating a plurality of virtual processing entities within the computer network; and
triggering a parallel processing of the multiple input portions using the plurality of virtual processing entities.

5. The method of claim 1, the processing routine further comprising instantiating a virtual storage entity, the triggering of an execution of the input command using the first virtual processing entity comprising causing the first virtual processing entity to execute a job process incorporating a portion of the execution of the input command using the first virtual processing entity, the instantiation of the first virtual processing entity comprising configuring the first virtual processing entity to provide the job process with at least one of a read access to the virtual storage entity, and a write access to the virtual storage entity.

6. The method of claim 5, the processing routine further comprising writing to virtual storage entity job input data to be used as input to the job process, the instantiation of the first virtual processing entity comprising:
configuring the first virtual processing entity to provide the job process with a read access to the virtual storage entity; and
configuring the first virtual processing entity to provide the job input data as input to the job process by reading the job input data from the virtual storage entity.

7. The method of claim 5, the execution of the job process resulting in a generation of job output data, the instantiation of the first virtual processing entity comprising:
configuring the first virtual processing entity to provide the job process with a write access to the virtual storage entity; and
configuring the first virtual processing entity to store the job output data by writing the job output data to the virtual storage entity.

8. The method of claim 5, the execution of the job process comprising executing a job code, the processing routine further comprising writing the job code to the virtual storage entity, the instantiation of the first virtual processing entity comprising configuring the first virtual processing entity to:
obtain a read access to the virtual storage entity;
start the job process by performing a job start routine comprising reading the job code from the virtual storage entity; and
execute the job process by performing a job execution routine comprising executing the job code read from the virtual storage entity.

9. The method of claim 5, the processing routine further comprising terminating the virtual storage entity in response to receiving of the resulting output.

10. The method of claim 5, the processing routine further comprising mounting the virtual storage entity to a filesystem of the computing device.

11. The method of claim 1, the processing routine further comprising terminating the first virtual processing entity in response to receiving of the resulting output.

12. The method of claim 1, the execution of the input command using the first virtual processing entity comprising an execution of a job code by the first virtual processing entity, the instantiation of the first virtual processing entity comprising transferring the job code to the first virtual processing entity.

13. The method of claim 1, the performance of the processing routine being transparent to a user of the computing device.

14. The method of claim 13, the execution of the input command using the first virtual processing entity comprising executing a job process by the first virtual processing entity, the processing routine further comprising:
generating a local process identifier on the computing device; and
linking the local process identifier to a job process identifier generated by the first virtual processing entity to represent the job process, the linking comprising making job process metadata associated with the job process available to the computing device using the local process identifier.

15. The method of claim 13, the input command being configured to direct the resulting output to an intended data stream of the computing device, the execution of the input command using the first virtual processing entity comprising an execution of a portion of the input command by a last virtual processing entity instantiated within the computer network by the computing device performing the processing routine, the execution of the portion of the input command by the last virtual processing entity resulting in a portion of the resulting output, the instantiation of the last virtual processing entity comprising configuring the last virtual processing entity and the computing device to automatically relay the portion of the resulting output from the last virtual processing entity to the intended data stream via the computer network.

16. The method of claim 13, the processing routine being started by an aliased command called by the trigger signal.

17. The method of claim 1, the processing routine further comprising determining, based on the input command, an optimal configuration of the first virtual processing entity for the execution of the input command using the first virtual processing entity, the instantiation of the first virtual processing entity comprising applying the optimal configuration to the first virtual processing entity.

18. A computing device comprising a processor and a memory and being configured for exchanging information with a computer network, the memory storing program instructions which, when executed by the processor, cause the computing device to perform a method of processing an input command, the method comprising:
in response to receiving a trigger signal configured to cause the computing device to process the input command, performing a processing routine comprising:
in response to determining that the input command shall be processed using distributed execution:
instantiating a first virtual processing entity within the computer network;
triggering an execution of the input command using the first virtual processing entity, the execution resulting in a resulting output;
receiving the resulting output from the computer network; and
providing the resulting output.

19. A computer program product comprising a computer readable storage medium having program instructions embodied therewith, the program instructions being executable by a processor of a computing device configured for exchanging information with a computer network, wherein execution of the program instructions by the processor causes the computing device to perform a method of processing an input command, the method comprising:
in response to receiving a trigger signal configured to cause the computing device to process the input command, performing a processing routine comprising:
in response to determining that the input command shall be processed using distributed execution:
instantiating a first virtual processing entity within the computer network;
triggering an execution of the input command using the first virtual processing entity, the execution resulting in a resulting output;
receiving the resulting output from the computer network; and
providing the resulting output.
